(19) United States
(12) Patent Application Publication
(10) Pub. No.: US 2002/0059513 A1
(43) Pub. Date: May 16, 2002

(54) System and method for configuring equipment

(75) Inventor: Peter Trefonas III, Medway, MA (US)

Correspondence Address: S. Matthew Cairns, c/o EDWARDS & ANGELL, LLP, Dike, Bronstein, Roberts & Cushman, IP Group, P.O. Box 9169, Boston, MA, 02209, US

(73) Assignee: Shipley Company, L.L.C., Marlborough, MA

(21) Appl. No.: 10/035,996

(22) Filed: Nov. 9, 2001

Related U.S. Application Data
(60) Provisional application No. 60/247,308, filed on Nov. 10, 2000.

(51) Int. Cl. G06F 9/00

(52) U.S. Cl. 713/1

(57) ABSTRACT

A system and method is provided for configuring equipment to achieve a desired result and includes a simulation engine for receiving the desired result and outputting at least one parameter setting for operating the equipment to achieve the desired result. Also included is a consumable knowledge base for receiving the at least one parameter setting and outputting a consumable selection for use in the equipment to achieve the desired result.

### BACKGROUND

The following invention relates to a system and method for providing technical support and, in particular, to a system and method for providing technical support for configuring equipment to achieve a desired result.

Manufacturing processes often involve the use of sophisticated equipment that requires expertise to operate correctly. For example, with respect to the process of exposing a circuit pattern on a wafer to be used as an integrated circuit, various equipment is used including an automatic wafer tracker, an automatic wafer polisher and a wafer stepper. To achieve the desired results using the wafer stepper, for instance, a number of operational parameters must be set including the adjustable numerical aperture, the adjustable partial coherence, the pupil shape, the baking temperature and the baking time. In addition, the correct photoresist and developer chemicals must be used. Thus, numerous decisions must be made correctly in order successfully produce the integrated circuit.

Because such sophisticated equipment is difficult to operate, users of such equipment typically rely on the expertise and support of the equipment manufacturer and the consumables supplier to configure the equipment and select the consumables to achieve optimal results. Often, such technical support requires technicians from the equipment manufacturer and/or the consumable supplier to either visit the equipment site or to analyze samples sent to them in order to determine the proper settings for the equipment.

The existing process for configuring sophisticated equipment is inefficient. First, skilled technical support personnel are expensive and often in short supply thereby increasing the costs of providing technical support. The expense and shortages associated with providing technical support is exacerbated in situations where onsite visits by technical personnel is required. In addition, customers may use the equipment without having the proper expertise or support in which case time and consumables are wasted. Furthermore, a shortage of technical support also may limit a customer's willingness and ability to investigate using the equipment in novel ways.

Tools exist for simulating the operation of certain equipment for the purpose of determining the parameter settings of the equipment that could be used to achieve a desired result. For example, Finle Technologies, (http://www.finle.com/), provides a simulation tool called Prolith for determining equipment parameters that may be used for achieving a desired result in a microlithography process. While the prior art simulation tools assist in determining equipment settings, they do not, however, address the problem of selecting the right consumables to be used with those equipment settings given a particular piece of equipment. Because there are numerous consumables in each consumable category that are similar but have distinct uses, specialized expertise is required to choose the right consumable to achieve the desired results. Thus, the prior art simulation tools are deficient because they do not provide users with a consumable selection to be used to achieve the desired result.

Accordingly, it is desirable to provide a system and method for providing technical support for configuring equipment to achieve a desired result in an efficient and cost effective manner.

### SUMMARY OF THE INVENTION

The present invention is directed to overcoming the drawbacks of the prior art. Under the present invention, a system and method is provided for configuring equipment to achieve a desired result and includes a simulation engine for receiving the desired result and outputting at least one parameter setting for operating the equipment to achieve the desired result. Also included is a consumable knowledge base for receiving the at least one parameter setting and outputting a consumable selection for use in the equipment to achieve the desired result.

In an exemplary embodiment, the system is in communications with the equipment and the system communicates the at least one parameter setting to the equipment for setting the equipment according to the at least one parameter.

Accordingly, a system and method is provided for configuring equipment so that a desired result may be achieved in an efficient and cost effective manner.

The invention accordingly comprises the features of construction, combination of elements and arrangement of parts that will be exemplified in the following detailed disclosure, and the scope of the invention will be indicated in the claims. Other features and advantages of the invention will be apparent from the description, the drawings and the claims.

### DESCRIPTION OF THE DRAWINGS

For a fuller understanding of the invention, reference is made to the following description taken in conjunction with the accompanying drawings, in which:

FIG. 1 is block diagram of a system for configuring equipment to achieve a desired result, in accordance with the present invention.

### DETAILED DESCRIPTION OF THE PREFERRED EMBODIMENTS

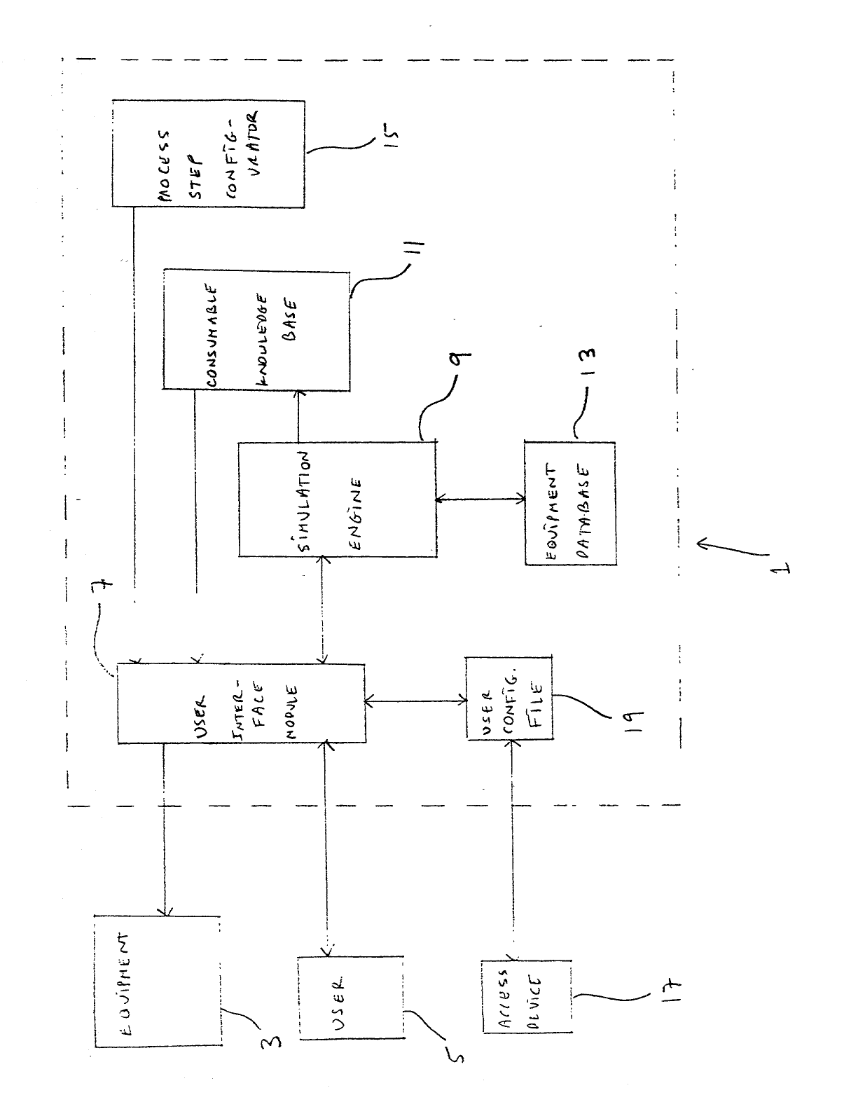

Referring now to FIG. 1, there is shown a system 1 for configuring equipment 3 to achieve a desired result, in accordance with the present invention. Equipment 3 may include any type of equipment that performs a function or process and that requires the equipment operator to set at least one parameter and select at least one consumable to be used in equipment 3 in order for equipment 3 to produce the desired result. By way of non-limiting example, equipment 3 may be a wafer stepper used in the process of exposing a circuit pattern on a wafer. To operate the wafer stepper, a number of parameters must be set on the wafer stepper including the adjustable numerical aperture, the adjustable partial coherence, the pupil shape, the exposure dose and the focal setting. In addition, the correct consumables must be used in the lithographic process, such as the appropriate photoresist and developer chemicals. Similarly, equipment 3 may include any other equipment that must be configured to operate as desired.

A user 5 operating, for example a personal computer, communicates with system 1 using any known communications medium or protocol, such as the Internet. System 1 includes a user interface module 7 that receives a configuration request from user 5. The configuration request includes the brand and type of equipment user 5 is using and the desired result user 5 would like to achieve with the equipment. For example, if user 5 desires to expose a pattern on a wafer, user interface module 7 may query user 5 as to what brand of stepper and track user 5 is using. User interface module 7 may also query user 5 with respect to further details regarding the equipment such as what type of hotplates or spray nozzle is included in the equipment. User interface module 5 then queries user 5 on the user's imaging objective, for e.g., the size, pitch, film thickness, phase shifters and pattern type desired. In responding to such queries, user 5 may transmit to user interface module 5 a drawing that represents the desired pattern. Such drawing may be created by user 5 with a computer-aided design software program and be transmitted to user interface module 7 in a computer readable format, in a manner well known in the art. Also, in the configuration request, user 5 may add any other constraints that user 5 desires for system 1 to consider including, by way of non-limiting example, the cost of achieving the desired result.

System 1 also includes a simulation engine 9 that receives the configuration request from user interface 7 and outputs parameter settings to be used to configure the equipment specified in the configuration request in order to achieve the desired results. Simulation engine 9 is in communications with an equipment database 13 which stores equipment model types and features thereby enabling simulation engine 9 to select parameter settings for the particular type of equipment included in the configuration request from user 5. In an exemplary embodiment, simulation engine 9 also outputs the simulation results that may include, for example a graphical or tabular representation of the expected results based on the recommended parameters. Simulation engine 9 may be, for example, a lithographic simulation program, such as the Prolith system from Finle, that receives as input the imaging objectives of user 5 and outputs the stepper settings to be used to achieve the desired results. These settings may include, by way of non-limiting example, the numerical aperture, the partial coherence, the pupil shape, the exposure dose and the focal setting, as well as the best mask correction methods to use, such as scatter bars, serifs or phase shifters. The parameter settings and simulation results are then output by simulation engine 9 to user interface module 7.

Also included in system 1 is a consumable knowledge base 11 that receives the parameter settings output from simulation engine 9 and determines the consumables that would best accomplish the result indicated in the configuration request given the type of equipment being used and the parameter settings output by simulation engine 9. For example, if simulation engine 9 is a lithographic simulation program that outputs the suitable parameters for a stepper, consumable knowledge base 11 may output the optimal primer, photoresist, developer, remover and edge bead remover that should be used by user 5 to best achieve the results indicated in the configuration request. Consumable knowledge base 11 then outputs the consumables selection to user interface module 7.

Also included in system 1 is a process step configurator 15 that includes a database of preferred process steps for achieving a desired result using particular equipment, configured a particular way and using particular consumables. Process step configurator 15 receives as inputs the configuration request, the parameter settings, the selected consumable and outputs a recommended step-by-step process for achieve the results indicated in the configuration request. For example, process step configurator 15 may output a recommendation covering the step-by-step process for producing a wafer including the process steps of coating, edge-bead removal, baking, stepping, post-exposure baking and developing.

User interface module 7 receives the configuration response, that includes the parameter settings, consumable selections, as well as recommended process steps and simulation results, and outputs this information to user 5. In an exemplary embodiment, user interface module 7 outputs the parameter settings in a format that may be directly received by equipment 3 for setting the parameters on equipment 3. For instance, user interface module 7 may output detailed track and stepper programs that directly configure track and stepper equipment for optimally performing the coating, edge-bead removal, baking, stepping, post-exposure baking and developing process steps.

User interface module 7 also outputs the configuration response to a user configuration file 19 for retrieval at a later time by either user 5 or an operator of access device 17 for performing various functions such as, by way of non-limiting example, customer support.

Accordingly, a system and method is provided for configuring equipment to achieve a desired result in an efficient and cost effective manner. By using the system and method of the present invention, a user is provided with parameter settings, consumable settings and a recommended process for operating equipment to achieve the desired result.

It will thus be seen that the objects set forth above, among those made apparent from the preceding description, are efficiently attained and, since certain changes may be made in carrying out the above process, in a described product, and in the construction set forth without departing from the spirit and scope of the invention, it is intended that all matter contained in the above description shown in the accompanying drawing shall be interpreted as illustrative and not in a limiting sense.

It is also to be understood that the following claims are intended to cover all of the generic and specific features of the invention herein described, and all statements of the scope of the invention, which, as a matter of language, might be said to fall therebetween.

1. A system for configuring equipment to achieve a desired result, comprising:
a simulation engine, said simulation engine receiving said desired result and outputting at least one parameter setting for operating said equipment to achieve said desired result; and
a consumable knowledge base, said consumable knowledge base receiving said at least one parameter setting and outputting a consumable selection for use in said equipment to achieve said desired result.

2. The system of claim 1, wherein said system is in communications with said equipment and said system communicates said at least one parameter setting to said equipment for setting said equipment according to said at least one parameter.

3. The system of claim 1, further comprising a configuration file for storing said desired result, a reference to said equipment, said at least one parameter setting and said consumable selection.

4. The system of claim 1, wherein said simulation outputs a simulation result.

5. The system of claim 1, further comprising a process step configurator, said process step configurator receiving the desired result, the at least one parameter setting and the consumable selection and outputting a step-by-step process for achieving the desired result.

6. A method for configuring equipment to achieve a desired result, comprising the steps of:
receiving said desired result into a simulation engine;
outputting from said simulation engine at least one parameter setting for operating said equipment to achieve said desired result; and
outputting a consumable selection for use in said equipment to achieve said desired result.

7. The method of claim 6, further comprising the step of:
setting said equipment according to said at least one parameter.

8. The method of claim 6, further comprising the step of:
storing said desired result, a reference to said equipment, said at least one parameter setting and said consumable selection to a configuration file.

9. The method of claim 6, further comprising the step of:
outputting from said simulation engine a simulation result.

10. The system of claim 1, further comprising the step of:
outputting a step-by-step process for achieving the desired result based on the desired result, the at least one parameter setting and the consumable selection.
